(19) United States
(12) Patent Application Publication
(10) Pub. No.: US 2003/0117959 A1
(43) Pub. Date: Jun. 26, 2003

(54) Methods and apparatus for placement of test packets onto a data communication network

(76) Inventor: Igor Taranov, Port Coquitlam (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/006,157

(22) Filed: Dec. 10, 2001

(51) Int. Cl. H04L 12/26

(52) U.S. Cl. 370/241

(57) ABSTRACT

A test packet sequencer for dispatching test packets onto a computer network comprises a computer running software under an operating system. The software uses I/O completion ports to dispatch packets and bursts of packets. The packets may be dispatched to travel a path in the network which terminates at the test packet sequencer. The software may also receive and time stamp returning packets and bursts of packets. The test packet sequencer may receive the packets in I/O completion ports. The software may have a test handler thread which terminates its current time slice just prior to sending a burst of packets so that the packets are all dispatched within a single time slice of the test handler thread. The test handler thread may be assigned a time critical priority.

### TECHNICAL FIELD

This invention relates to the placement of test packets onto an IP network. More particularly, it relates to apparatus and methods for accurately placing packets and bursts of packets onto an IP network and/or receiving and time stamping packets and bursts of packets. The invention may be applied in the fields of network measurement and diagnostics.

### BACKGROUND

The performance of an IP network is measured by the bandwidth and reliability with which it can transfer packets of information from one location on the network to another. A typical IP network comprises a number of packet handling devices which are interconnected by data links. The packet handling devices may include routers, switches, bridges and the like. The data links may include various transmission media such as optical fibers, wireless connections, wired connections, connections over telephone lines, and the like. Data may be transferred across the data links through the use of various networking protocols.

The operation of a computer network depends upon many interacting factors including the ways in which different packet handling devices on the network are configured, the types of data links, usage of links in the network, and so on. Defects or mis-configurations of individual network components can have severe effects on the performance of the network. There exist various methods for measuring network performance and identifying causes for substandard network performance. Some of these methods sending packets, or bursts of packets, along one or more paths through the network. Information regarding the network's performance can be obtained by observing characteristics of the packets as they propagate through the network.

One example of network analysis software which uses test packets to measure network performance is a “shareware” utility called “pchar”. Pchar operates on computers running the UNIX operating system. Pchar obtains measures of the bandwidth, latency, and loss of links along an end-to-end path through a network by monitoring the dispersion of test packets as they propagate through the network. Pchar is of limited use for testing high speed networks because it can place packets onto a network only relatively slowly. Pchar uses standard application programming interfaces (APIs) to control a network card to place packets onto a network. This results in relatively wide spacing of the test packets.

PCT patent publication No. WO 92/22967 describes a method and apparatus for using a “loop back” test on a packet-based network to discern the characteristics of the network by observing the effects the network has on the test packets.

There exist hardware-based network protocol analyzers which are capable of placing packets onto a network. Such protocol analyzers comprise specialized hardware and are typically very expensive.

There exists a need for apparatus and methods for placing packets and sequences of packets accurately and quickly onto a network. There is a particular need for such apparatus and methods which can be implemented using commonly available and cost effective hardware.

### SUMMARY OF THE INVENTION

This invention relates to a system for accurately placing test packets onto a data communication network. The system may comprise a general purpose computer running an application under a non-real time operating system comprising a graphical user interface. For example, some embodiments of the invention comprise a software application running under the Microsoft™ Windows 2000 operating system.

Another aspect of the invention relates to methods and apparatus for receiving and time stamping test packets. Apparatus of the invention may comprise a system for accurately placing test packets onto a data communication network integrated with a system for receiving and time stamping returning test packets.

Further features of the invention are described below.

### BRIEF DESCRIPTION OF THE DRAWINGS

In drawings which illustrate non-limiting embodiments of the invention:

FIG. 1A is a schematic diagram of a network into which packets may be transmitted according to the methods of the invention;

FIG. 1B is a diagram of a test packet sequencer according to some embodiments of the invention;

FIG. 2 is a block diagram illustrating a sequence of test packets;

FIG. 3 is a Van Jacobson diagram showing how the temporal distribution of a burst of four packets is modified by variations in the capacities of network links that the packets pass through;

FIG. 4 is a schematic diagram illustrating how a bottleneck can affect network performance;

FIG. 5 is a schematic diagram of a system according to an embodiment of the invention;

FIG. 6 is a flowchart illustrating the operation of a test packet sequencer according to the invention; and,

FIG. 7 is a UML (Unified Modeling Language) layered C++ class diagram test packet sequencer software according to an embodiment of the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The following description describes a test packet sequencer according to an embodiment of the invention which comprises a computer running the Microsoft Windows 2000 operating system. A test packet sequencer according to the invention may also be implemented in other operating systems which provide a completion port mechanism. The test packet sequencer generates individual packets and/or groups (“bursts”) of accurately spaced-apart test packets and places the test packets and bursts of test packets onto a data communication network to which the computer is connected.

The test packet sequencer can measure departure and return times of individual test packets. In preferred embodiments, the test packet sequencer can automatically measure departure and return times for packets which traverse an entire path as well as for packets which traverse portions of the path which end at intermediate nodes along the path.

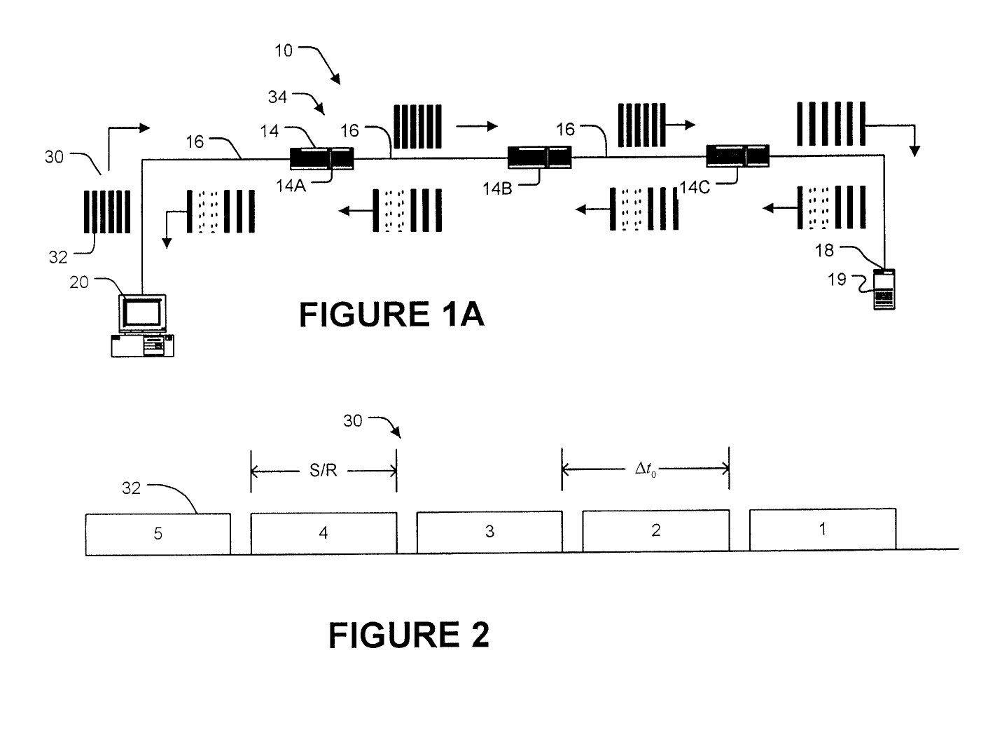

FIG. 1 shows a network 10 comprising an arrangement of network devices 14 (the network devices may comprise, for example, routers, switches, bridges, hubs and the like). Network devices 14 are interconnected by data links 16. The data links may comprise physical media segments such as electrical cables, fibre optic cables, or the like or transmission type media such as radio links, laser links, ultrasonic links, or the like.

A test packet sequencer 20 is connected to network 14. Test packet sequencer 20 comprises a host computer 22 (FIG. 1B) which includes a network interface 24 and runs test packet sequencer software 26 under an operating system 28. Operating system 28 may be a version of the Microsoft™ Windows™ operating system such as Microsoft Windows 2000™.

One way to use test packet sequencer 20 is to generate one or more sequences of test packets, send those test packets on network 14 to a destination, such as an end host 18, and to measure the times at which each of the test packets is dispatched from test sequencer 20 and received back at test packet sequencer 20.

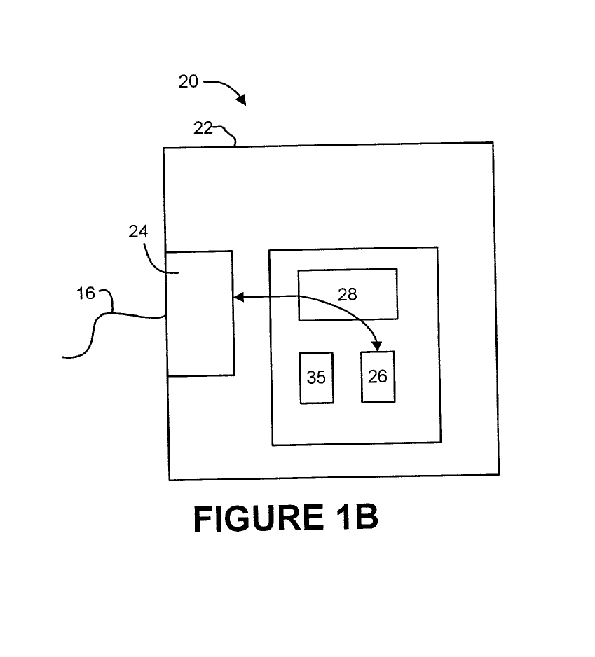

Test packet sequencer 20 generates groups (or “bursts”) 30 of packets 32. As shown in FIG. 2, each packet 32 in a burst 30 has a size S. In an ethernet network, S is typically in the range of about 46 bytes to about 1500 bytes. The packets in burst 30 are dispatched in sequence. Each packet is completely dispatched in a time S/R where R is a rate at which the data of the packet is placed onto the network. The sequentially adjacent packets 32 in a burst 30 are separated by an interval Δt₀. In many cases it is desirable that the packets in a burst 32 be very closely spaced (so that Δt₀ is approximately equal to S/R). In general, S and Δt₀ do not need to be constant for all packets 32 in a burst 30 although it can be convenient to make S and Δt₀ the same for all packets 32 in each burst 30.

The packets in burst 30 are sent along a network path 34. In the illustrated embodiment, network path 34 extends from test packet sequencer 20 to an end host 18 and back to test packet sequencer 20. Path 34 may, for example, be a path on which data from an application 35 hosted on host computer 22 is expected to travel en route to end host 18. As packets 32 pass along path 34 through network devices 14 and data links 16, individual packets 32 may be delayed by different amounts. Some packets 32 may be lost in transit.

Various characteristics of the network devices 14 and data links 16 along path 34 can be determined by observing how the temporal separation of different packets 32 in sequence 30 varies and observing patterns in the losses of packets 32 from bursts 30.

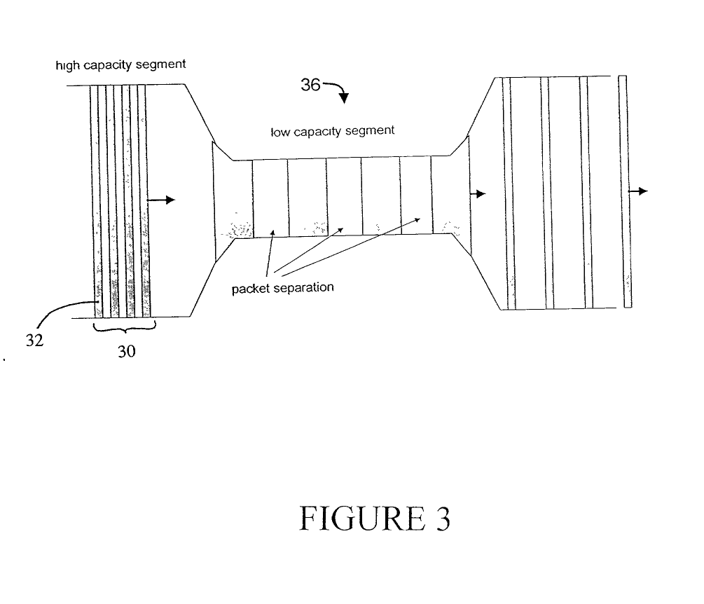

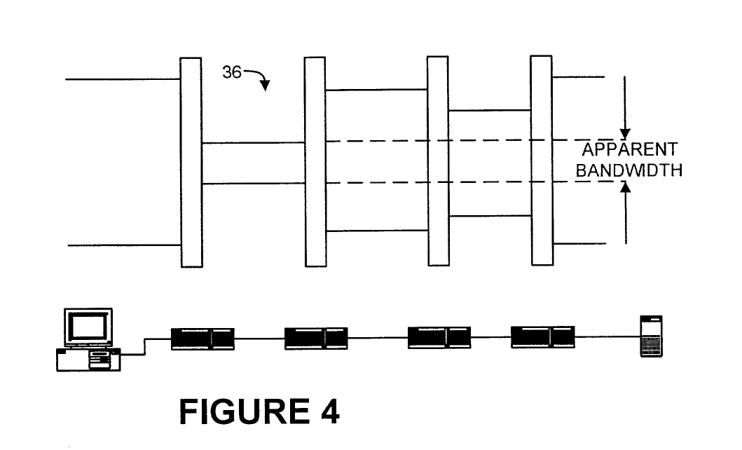

For example, the bandwidth of an end-to-end path 34 can be estimated by monitoring the separation of packets 32 in a burst 30. As shown in FIGS. 3 and 4, if packets 32 are dispatched at times which are closely enough spaced then the presence of a bottleneck 36 (i.e. a low capacity segment) on path 34 will increase the separation between adjacent packets 32. The increase in separation will be a function of the packet size S and the capacity of bottleneck 36.

Consider the simple case of a burst of two packets 32, each of size Sₚₖₜ. If the two packets are dispatched with a separation Δt₀ (i.e. a time Δt₀ elapses between the end of a first packet and the end of a second packet which immediately follows the first packet) they may have a separation of Δt₁ when they return to test packet sequencer 20. If Δt₀ is large, the bottleneck 36 will not have an appreciable effect on Δt₁. However, if Δt₀ is small so that Δt₁>>Δt₀, an estimation of the bandwidth can be made using the derived expression:

$$B W \approx \frac{{S}_{pkt}}{Δ {t}_{1}} \qquad ( 1 )$$

The expression of Equation (1) provides only a crude estimate of bandwidth. Better estimates can be obtained by performing statistical analyses on the separations between a number of returning packets, using larger bursts of packets or using more detailed calculations.

In general, obtaining, accurate information about a network 14 based upon differences between the temporal separation between packets 32 of a burst 30 when the packets are dispatched and the temporal separation between the packets when they are received at a point in network 14 requires that the packets 32 be dispatched with accurately controlled temporal separations. For certain types of measurements, packets 32 must be dispatched in a tightly spaced burst wherein the temporal separation between adjacent packets is very small.

If packets 32 are initially dispatched onto network 14 with temporal separations which are not well controlled then the measured values of Δt₁ become less reliable as a basis for obtaining information about the network. The magnitude of the variations in Δt₁ which result from changes in bandwidth along a path 34 depends upon the speed of the data links of network 14 among other factors. Table I summarizes the range of variation in Δt₁ which would be typically experienced when measuring network link speeds using 1500 byte packets. For example, where network 14 comprises a 10 Mb/s Ethernet network one might experience variations in Δt₁ on the order of 1 ms. Where network 14 comprises a 1 Gb/s Ethernet network one might experience variations in Δt₁ on the order of 10 μsec.

TABLE I
Example Time Variations

| Network Type | Speed (Mbs) | Δt₁ (μ sec) |
|---|---|---|
| 10baseT | 10 | 1200 |
| T3 | 45 | 267 |
| 100baseTX | 100 | 120 |
| OC-3 | 150 | 80 |
| OC-12 | 622 | 19 |
| GigEthernet | 1000 | 12 |
| OC-48 | 2488 | 4.8 |

To facilitate bandwidth measurements it is desirable that packets 32 should be dispatched such that the temporal spacing Δt₀ between adjacent packets 32 is small compared to the applicable time listed in Table I (or a similar time constant in the case of a networking technology not listed in Table I). This requires Δt₀ to be controlled to a resolution better than the values given for Δt₁ in Table I. Where packets 32 are actually dispatched at times which vary from the intended times (i.e. where there are significant undesired and practically unpredictable variations in Δt₀) there can be large variations in bandwidth estimates from burst to burst.

It is also desirable that the system which detects the packets after they have traveled along path 34 be able to measure the spacing between adjacent packets to a resolution better than the values given for Δt₁ in Table I. Typical methods which use operating system APIs are incapable of controlling the times at which packets are dispatched to resolutions good enough for high accuracy measurements of bandwidth and other characteristics. Such methods are typically also incapable of measuring the times at which packets are received to desired resolutions.

The higher the speed of network 14 and the shorter the propagation delay (one-way travel time) along path 34, the more closely packets 32 must be spaced when they are dispatched. Packets 32 that are sent with large Δt₀ cannot measure the full bandwidth of high-speed links.

In preferred embodiments of the invention, test packet sequencer 20 comprises software 26 which runs on the same hardware, within the same operating system, and in the presence of the same processes as an application 35 which uses network 14 and for which the parameters being measured has some relevance. Software 26 operates in a manner such that packets 32 are dispatched with minimal interference from the operating system 28. Preferably software 26 interferes minimally with the operation of other software which may be running on computer 22.

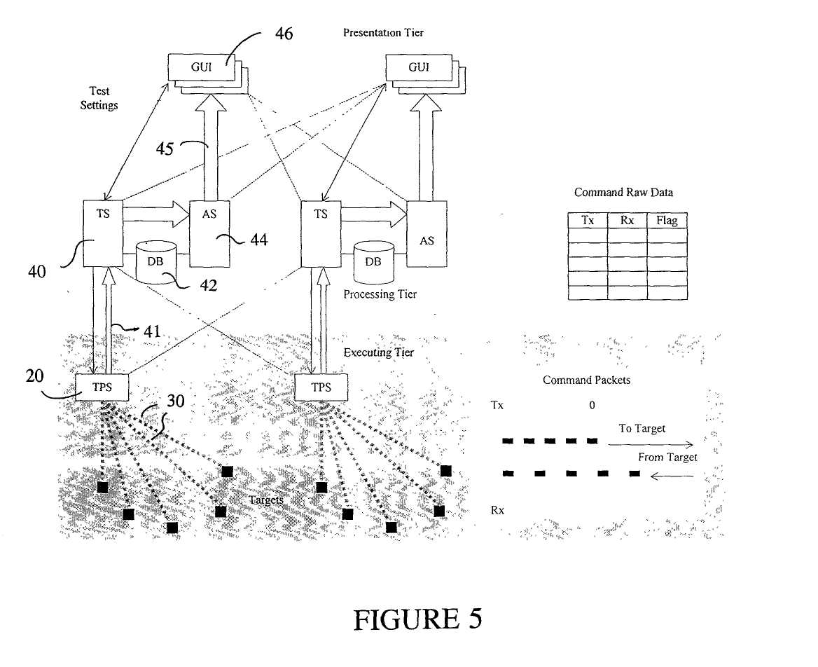

Software 26 may be incorporated into, or constructed to operate in response to requests from application 35 which uses data communication on network 14. Analysis of data collected by test packet sequencer 20 may be performed in a separate system. For example, FIG. 5 shows a possible organization of a network testing system which includes a test packet sequencer 20. An example of such a system is described in the commonly owned co-pending application entitled SIGNATURE MATCHING METHODS AND APPARATUS FOR PERFORMING NETWORK DIAGNOSTICS filed Nov. 22, 2001, which is incorporated herein by reference. In the illustrated embodiment, test packet sequencer 20 can generate bursts 30 of tightly controlled packets 32 which travel along a path 34 which begins and ends at the test packet sequencer 20. Test packet sequencer 20 can also detect the return of packets 32 and compile information regarding the propagation of test packets 32 through network 14.

Test packet sequencer 32 may operate under the control of a test server 40. Test server 40 causes test packet sequencer 32 to perform a sequence of commands. Test packet sequencer 32 executes the commands, some of which cause test packet sequencer 20 to generate specified bursts 30 of test packets 32, and returns information 41 regarding the propagation of those test packets 32 to test server 40.

A test, as a logical entity, may comprise multiple commands which may all be of different types, of the same type, or of mixed types. Each type of command specifies certain actions to be taken by test packet sequencer 32. In general, each command requires one or more packets to be sent, received and time stamped by test packet sequencer 32. Different types of commands may specify specific ways in which packets are to be sent and processed upon their return. Commands may include:

a connectivity command to check a connectivity to a destination;

a trace route command to discover a network path to a destination;

a MTU command to discover path MTU and potential related conflicts; and,

datagram and burst commands to gather statistical information about the propagation of datagrams and bursts along a specified network path.

A test may be specified by a set of test settings. Each set of test settings may specify, for example:

a set of commands to be included in a test;

a sequence in which the commands are to be executed;

a number of times the execution of each command should be repeated; and,

command settings for each command.

The command settings specify parameters that affect the operation of each command. The command settings for a burst command may specify, for example:

a distribution address for the burst;

a number of packets in the burst;

a size of the packets in the burst;

data content for packets in the burst;

a number of times each packet sending is to be repeated;

time intervals between packets;

a time within which all packets are expected to return;

an action to take if the command fails; and,

so on.

Test settings for various tests may be stored in a database 42. A user who wishes to perform a test may find a suitable set of test settings in database 42. If not, the user can retrieve a set of test settings from database 42 and modify it by overwriting default settings to perform the desired test. Default settings may be changed without recompiling any binary code. In the alternative, a user may create a new set of test settings to be used to perform a desired test.

A user may use a user interface, preferably a graphical user interface (GUI) 46 to select a test to be performed. GUI 46 permits users to initiate tests, obtain information about the status of analysis server 44 and test server 40, and to view the test result data 47. The test settings for the selected test are provided by a test server 40 to test packet sequencer 32. Test packet sequencer 32 executes the test by executing test commands according to the test settings. At suitable times, such as after the execution of each command, test packet sequencer 32 sends to test server 40 raw data regarding the test results. The raw data may comprise, for example, departure and return times for all packets sent during execution of the command.

Where the path 34 for which a test is to be executed comprises a number of hops, test packet sequencer 20 may automatically repeat the test treating the node at the end of each hop as an end host. This allows data to be collected which can be used to analyze the performance of each link in path 34.

Test server 40 provides the raw data 41 to an analysis server 44. Analysis server 44 processes raw data 41 to obtain reduced test data 45. The reduced test data may comprise statistical information derived from raw data 41. Analysis server 44 processes reduced test data 45 to obtain test result data 47. Test result data 47 may contain, for example, estimates for a destination and for intermediate nodes along a path 34 of network parameters such as:

the bandwidth of various data links along path 34;

utilization of various data links on path 34;

jitter;

propagation delay;

queue depth; and/or,

other network performance indicators.

Test result data 47 may also include information regarding the presence of various detected conditions such as:

half-full duplex conflicts;

MTU conflicts; and

other conditions affecting the network.

It may be desirable to provide to a user intermediate results before a test has been completed. Analysis server 44 may derive intermediate test result data 47 from the reduced test data 45 as a test progresses and deliver the intermediate test result data to GUI 46. GUI 46 then displays and updates the calculated data and provides to the user an indication of a status of the running test. Upon the completion of a test analysis server 44 stores the final reduced test data and test result data in database 42.

A user of GUI 46 may initiate and monitor multiple concurrent tests executed by the same or different test packet sequencers. The user may also cause GUI 46 to request from analysis server 44 and display the test result data for previously executed tests.

Test packet sequencer software 26 can function even when running under a non-real time operating system like Windows 2000 which handles requests for resources from running processes to optimize their shared use. In such operating systems it is difficult to cause packets 32 to be reliably dispatched at closely spaced intervals or to accurately time stamp the arrivals of returning packets 32. In software which is written using conventional programming techniques running under such operating systems, the dispatch of a packet 32 (and/or the time stamping of a received packet 32) may be unpredictably delayed by factors such as:

interruptions and irregular delays in processing time as the CPU of computer 22 switches frequently between threads (roughly every 20 milliseconds in Windows 2000);

relatively long durations for thread context switching (commonly in the range 10-20 microseconds for Windows 2000);

overhead associated with the transition between user mode and kernel mode (roughly 1000 CPU instructions for Windows 2000);

delays in retrieving or storing data due to fragmentation of the memory allocated for application data;

the standard application program interfaces (APIs) provided in Windows 2000 and similar operating systems do not guarantee sufficient control over the details of packet transmission;

slow access to data due to misalignment of the data with memory page boundaries;

time taken to handle page faults which occur if the operating system unloads data from memory into a system page file;

use of the excessively sharable default application heap for storing packet data;

use of the standard exception handling mechanism provided by C++ compilers for exception handling which results in software which includes a large number of instructions which are associated with building exception frames capable of unwinding objects;

additional buffering of packets which occurs in the operating system's socket layer and is used by default to achieve smooth data transfer;

fragmentation of time-critical routines caused by their misaligning with thread time slice boundaries;

slow downs and related imprecision in timestamping as the network interface may block processing pending results; and,

generally non-optimized code for time-critical and/or processor-intensive functions.

The commonly used application program interfaces (APIs) provided in Windows 2000 and similar operating systems do not guarantee any level of performance or control over the details of packet transmission.

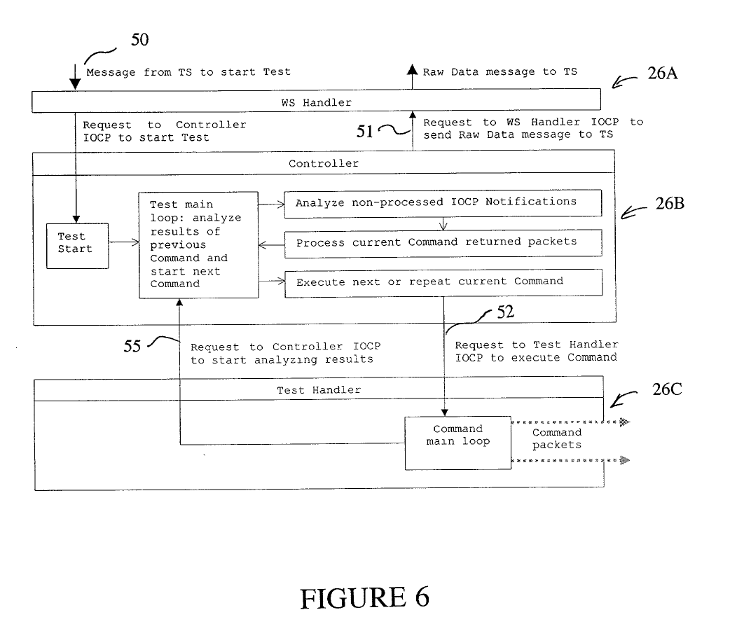

FIG. 6 shows a possible organization of functional layers into which test packet sequencer software 26 may be divided and illustrates a flow of information and execution control between those functional layers. Test packet sequencer software 26 comprises a socket layer 26A, a test controller layer 26B and a command controller layer 26C. Each layer deploys one I/O completion port 27 and one or more threads within which layer provides its functionality. Each I/O completion port 27 comprises an operating system kernel object. In the illustrated embodiment, I/O completion ports 27A, 27B and 27C are respectively associated with socket layer 26A, test controller layer 26B and command controller layer 26C. When one of completion ports 27 receives a notification from a process (or a notification from the O/S relating to activity on a notification from the operating system relating to activity on an I/O channel associated with the completion port), the completion port queues the notifications until at thread with which it is associated is available. The completion port then passes the data it has received to the associated thread.

At least timing critical input and output functions of each of these layers are performed through the associated I/O completion port 27. In preferred embodiments, all communications with other layers or system components including information about sending and receiving packets is performed by way of completion ports 27.

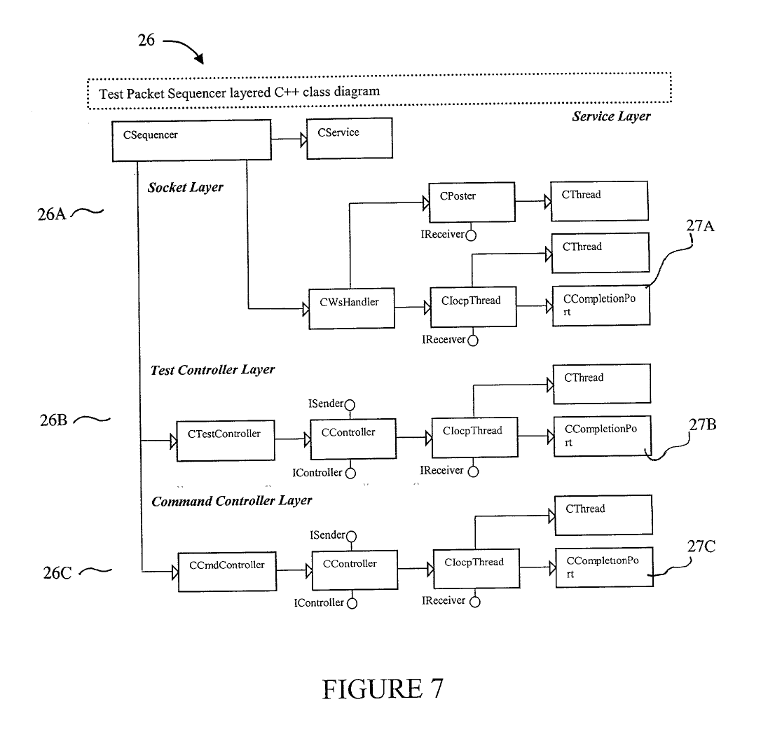

FIG. 7 is a layered UML C++ class diagram which illustrates a possible way in which functional layers 26A, 26B, and 26C may be implemented.

Socket layer 26A provides an interface to an analysis system (not shown in FIG. 6) which processes raw data 41 obtained by test packet sequencer 20. The analysis system may comprise a separate test server 40 which communicates with an analysis server 44, as shown in FIG. 5, a software module integrated with test packet sequencer 20, stand alone software, either running on computer 22 or distributed on one or more other computers, or the like.

In the embodiment of FIG. 5, socket layer 26A receives from test server 40 requests 50 to perform tests. The nature of each test is specified by test settings which are included in the corresponding request 50. Socket layer 26A passes the requests 50 to test controller layer 26B. This may be done by way of I/O completion port 27B. As raw test data becomes available, for example, after completion of each command in the test, test controller layer 26B passes the raw test data 41 back to socket layer 26A. This may be done by way of I/O completion port 27A. Socket layer 26A sends the raw data 41 to test server 40.

Test controller layer 26B controls the execution of each test. Test controller layer 26B may control the execution of multiple concurrent tests. After receiving a request 50 to perform a test, test controller layer 26B validates the test's test settings and parses the test settings into separate commands. Test controller layer 26B then sends individual commands in a sequence determined by the test settings to command controller layer 26C. This may be done by way of I/O completion port 27C.

In preferred embodiments, test packet sequencer 20 can execute commands which automatically send packets or bursts of packets over a path 34 which has its mid point at a destination device and over shorter paths which have mid points at network nodes which are between test packet sequencer 20 and the destination device. In such embodiments, test controller layer 26B also controls the sequence in which command is executed on the shorter paths by command controller layer 16C.

After receiving notification from command controller layer 26C that data regarding packets sent and received by a particular command is ready for analysis, test controller layer 26B may extract the raw test data from the data made available by command controller layer 26C and forward the raw test data 41 produced by that command to socket layer 26A.

Command controller layer 26C executes commands received from test controller layer 26B. Executing each command typically involves dispatches a test packet (datagram) or burst of test packets 32, and receiving and time stamping test packets 32 which return to test packet sequencer 20. The nature and number of test packets 32 dispatched are specified by the command settings for that command.

When all test packets 32 have returned (or the time since the packets 32 were dispatched exceeds a threshold) command controller layer 26C notifies test controller layer 26B (by passing a notification by way of I/O completion port 27B) that the data regarding the test packets is available. The notification may include a pointer to a location in memory of the data regarding the test packets. The threshold may be chosen to be large enough that the time required to switch back to a thread of command controller layer 26C upon arrival of another packet will not affect too much the accuracy with which the arrival of another packet can be time-stamped. For example, the threshold may be chosen to be 25 times larger than a time required to complete an operation in test controller layer 26B and pass control back to a thread of command controller 26C.

Command controller layer 26C sends and receives packets asynchronously. That eliminates unnecessary inter-packet interval related to waiting for the application level completion of sending the previous packet before submitting request for sending the next packet.

As noted above, software 26 preferably uses I/O completion ports for sending and receiving test packets 32. Each I/O completion port comprises an operating system kernel object which can handle multiple concurrent I/O requests. The IO completion port functions in a kernel mode in between the application and network protocol layers. Each I/O completion port 27 may be associated with one or more sockets whose data transfer is to be handled and one or more threads to which execution control should be passed for processing notifications about completed I/O requests. Completion ports 27 allow other threads to pass explicit application level notifications with attached data to the thread(s) associated with the I/O completion port.

Each I/O completion port 27 internally asynchronously queues I/O requests coming from user threads. When the completion port switches to kernel mode it executes the queued requests. Since completion ports 27 execute the queued I/O requests while operating in kernel mode, the execution of the requests suffer reduced interruptions. The requests can be executed quickly because completion ports 27 typically have faster access to protocol drivers than do the user threads of software 26. This allows outgoing packets 32 to be very closely spaced.

When an I/O completion port 27 completes an I/O request it notifies a first available one of the thread(s) associated with the completion port and passes execution control to the thread. This allows the thread to process the completed request. The thread may obtain a time stamp for the completed request among other processing functions.

In preferred embodiments of the invention, command controller layer 26C aligns packet sending routines with thread time slices by releasing the current time slice right before entering a time critical code (for example, just before dispatching a group of test packets by way of I/O completion port 27C). For a group 30 of packets 32 having a number of packets within a valid range for one command, a thread time slice (roughly 20 milliseconds for Windows 2000) is enough to pass all packets to completion port 27 within one time slice. This gives a highest chance that completion port 27C will be able to execute requests to send all of the test packets within the next kernel mode slice so that the test packets will be closely spaced as they are dispatched onto the network.

Dividing software 26 into functional units in a clear and logically consistent manner facilitates tuning the performance of test packet sequencer software 26 to achieve better control over the placement of packets onto a network and the time stamping of packets.

In preferred embodiments of the invention, while command controller layer 26C is sending and receiving packets of a particular command, it does virtually nothing else but time stamping of departing packets, time stamping of arriving packets and storing information about the departing and arriving packets in a suitable data structure such as a simple array for later processing. Test controller layer 26B is sleeping and does nothing until it is specifically awakened by command controller layer 26C passing to it a notification that data regarding test packets is available for processing.

Command controller layer 26C preferably has only one thread to avoid extra thread context switching. If during submitting a group of packets to I/O completion port 27C, one or more packets happen to be received, operating system 28 does not require to spend time on activating another thread to process the received packets as I/O completion port 27C passes completion notifications to the sole command controller thread. This facilitates time stamping of arrived packets very shortly after they are received at test packet sequencer 20.

Test packet sequencer software 26 may permit overlap between the receiving of test packets by the command controller thread and the analysis of data regarding the test packets to extract the raw test data by the test controller thread. The command controller thread may include a ‘start analyzing’ time value. If not all test packets have returned to test packet sequencer 20 and the since sending the last test packet in the current command exceeds the ‘start analyzing’ time value then the command controller thread sends notification to the test controller thread that it should start analyzing the test packets for the current command. The ‘start analyzing’ time value may be set to a time that is, for example, at least 25 times greater than a time required for the test controller thread to complete its time slice and yield execution control to the command controller thread. This causes the test to execute more quickly. The test controller thread preferably frequently tries to release its time slice. This permits the minimization of delays in processing returned test packets in cases where a packet arrives while the test controller thread is executing.

The command controller layer thread may be assigned a “time-critical” priority. This provides highest likelihood that the command controller thread will not be interrupted during sending and receiving packets, and that the command controller thread will gain execution control during the phase of receiving which may overlap with the analysis of packets by the test controller thread.

Command controller layer 26C preferably configures sockets by way of which test packets will be sent and received to not use intermediate buffering in operating system abstract socket layer. Operating systems typically set every new socket to use this buffering by default. The abstract socket layer provides this buffering to make data transmission smoother at the cost of extra time required for additional buffering. Without this option set, the protocol driver reads and writes packet data directly from and to packet buffers. Command controller layer 26C preferably locks the memory locations in which packet data is stored.

Command controller layer 26C preferably keeps track of a number of test packets 32 which are expected to return. Before executing a next command, controller layer 26C checks whether there are enough pending receive requests to handle all test packets 32 which could be received during execution of the next command. If not, then command controller layer 26C creates and submits to completion port required number of new receive requests. Number, which is considered as enough, is set greater then actual number of packets to account for possible ‘alien’ packets. This saves critical time later. Test creates in advance, or has created for it in advance, buffers sufficient for receiving returning test packets 32. The buffers include at least a minimum number of receive buffers required to receive all expected returning packets 32.

Command controller section 26C preferably uses a high resolution hardware counter for time stamping. The hardware time counter provides high time resolution. The resolution may be better than 300 nanoseconds on a computer equipped with an 800 MHz Pentium III processor.

Test packet sequencer software 26 preferably makes all memory allocation units for packet data of equal size to eliminate heap memory fragmentation. This also reduces time of memory access.

Test handler section 26C preferably maintains a private heap for packet data. This helps to avoid overhead and delays which can occur if the default application heap is excessively shareable and fragmented. The private heap may be configured by test packet sequencer software 26 to use as an allocation unit having a size equal to the memory page size used by operating system 28. For example, the page size may be 4096 bytes where the operating system is Windows 2000. This causes heap data to be aligned with memory page boundaries and reduces the time required for each memory access by eliminating instructions which would otherwise be required to read or write unaligned memory data.

Test packet sequencer software 26 preferably sets an application working process size bigger larger than the default working process size. In Windows 2000 the default working process size is 4 Mbytes. Data in excess of the application working process size may be unloaded by operating system 28 into a page file. A page fault occurs if there is an attempt to retrieve or modify data which has been unloaded into a page file. Using a larger application working process size minimizes the chance that page faults will occur during memory access.

Test packet sequencer may commence the execution of a command even through not all test packets sent in execution of a previous command have been returned. To facilitate this, test controller layer 26C may receive a ‘sleep’ time value as part of the command settings for a command. If a time elapsed since receiving the last packet from the currently executing command exceeds the ‘sleep’ time for the command then test controller layer 26C may start execution of a next command. The value for the sleep time is selected to be long enough that all test packets could return within the sleep time. With the proper setting for the sleep time it is relatively unlikely that packets will arrive during the execution of the next command. Overall test execution is not delayed due to extremely (abnormally) delayed or lost packets.

The sleep time may be automatically adjusted. One way to do this is for test controller layer 26B to dynamically adjust the sleep time value son the basis of the average round trip time for packets on the path 34 currently being tested. For example, the sleep time could be set to a multiple of the average round trip time for a packet of that size and for that network device which is currently being tested. The multiple could be, for example, in the range of 1½ to 3 times the average round trip time. The average round trip time may be obtained by averaging the round trip times for a number of previously sent packets (for example, the 10 most recently sent test packets).

As an alternative to measuring the sleep time from the time at which a last received packet was received, test packet sequencer software 26 may maintain a sleep time which specifies a time period by the end of which all packets in a burst 30 would be expected to have returned. The sleep time value may be set based in part upon one or more of a number of packets 32 in the burst 30, a size S of packets 32, and an estimated time for traversing path 34.

Test packet sequencer software 26 preferably does not use the exception mechanism provided for exception handling by a standard C++ compiler. The standard exception mechanism provides significant overhead relating to unwinding objects. In preferred embodiments of the invention this overhead is unnecessary. Instead, test packet sequencer software 26 may use structured exception handling (SEH).

A prototype test packet sequencer comprising software, as described above, running on a computer having an 800 mHz Pentium III processor under the Windows 2000 operating system. The computer was interfaced to a 100 Mbs ethernet network by way of a 3Com™ 10/100 Network Interface Card (NIC). The test packet sequencer was used to dispatch bursts of 1500 byte packets. The time between the starts of successive packets was measured using a SmartBits network analyzer. It was found that the time between the starts of successive packets was 123.5±0.05μ seconds. This indicates that there was essentially no gap between the end of one packet and the dispatch of the next packet.

The disclosed system and method for dispatching bursts of test packets and the disclosed system for receiving and time stamping the receipt of test packets may be used together, as described above, or separately. Either or both of these systems may be incorporated into a software-based system that can be used by users such as network engineers and managers to trouble-shoot and analyze their networks. Such systems may also be used as elements in systems for network decision making on routing or content selection, where a very fast, accurate characterization of a point-to-point network is required.

The test packet sequencing software could be used as part of a complete internet performance measurement system. The software could either be licensed to end users as a software product or access to results provided by the software could be provided as a service.

Certain implementations of the invention comprise computer processors which execute software instructions which cause the processors to perform a method of the invention. The invention may also be provided in the form of a program product. The program product may comprise any medium which carries a set of computer-readable signals comprising instructions which, when executed by a computer processor, cause the data processor to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:

The invention may be used, with suitable adaptations in implementation details, under an operating system other than Windows 2000 which provides, or is modified to provide I/O completion ports.

Accordingly, the scope of the invention is to be construed in accordance with the substance defined by the following claims.

What is claimed is:

1. A method for dispatching a burst of test packets onto a network, the method comprising:
generating a plurality of test packets;
forwarding to an I/O completion port a request that the test packets be dispatched; and,
dispatching the test packets onto the network using the I/O completion port.

2. The method of claim 1 wherein the packets are forwarded to the I/O completion port asynchronously;

3. The method of claim 1 wherein forwarding the test packets to the I/O completion port is performed by a user mode thread during a single time slice.

4. The method of claim 3 comprising:
before forwarding the test packets, terminating the current time slice for the user thread; and forwarding the test packets to the I/O completion port at a start of a next time slice for the user thread.

5. The method of claim 4 comprising assigning a time-critical priority to the user mode thread.

6. The method of claim 3 comprising assigning a time-critical priority to the user mode thread.

7. The method of claim 3 wherein the user mode thread accesses directly buffers in a network interface device.

8. The method of claim 3 comprising receiving returning dispatched test packets after they have traversed a path in the network and time stamping notifications that the packets have been received.

9. The method of claim 8 wherein the user mode thread creates in advance, or has created for it in advance, buffers sufficient for receiving all of the returning dispatched test packets.

10. The method of claim 9 wherein the user mode thread uses a hardware counter for time stamping returning packets.

11. The method of claim 9 comprising maintaining a private heap for packet data, wherein the private heap is accessible to the user mode thread.

12. The method of claim 11 wherein the private heap comprises standard-size allocation units for storing packets.

13. The method of claim 12 wherein the standard-size allocation units are of an operating system memory page size.

14. The method of claim 13 wherein the standard-size allocation units are 4096 bytes.

15. The method of claim 11 comprising assigning a larger than default process working set size to the user mode thread.

16. The method of claim 15 wherein the process working set size exceeds 8 Mbytes.

17. The method of claim 3 wherein the user mode thread accesses directly buffers in a network card from which the test packets are dispatched onto the network.

18. The method of claim 1 wherein generating the test packets comprises generating a plurality of equal-sized test packets.

19. The method of claim 1 wherein generating the test packets comprises generating ethernet test packets.

20. The method of claim 18 wherein generating the test packets comprises generating a plurality of equal-sized test packets wherein each of the test packets has a size in the range of 46 bytes to 1500 bytes.

21. The method of claim 1 comprising, receiving from the I/O completion port notifications that the packets have been dispatched and time stamping the notifications.

22. The method of claim 8 wherein receiving the returning dispatched packets comprises passing data for the returning dispatched packets through an I/O completion port associated with a network interface at which the returning dispatched packets are received.

23. A program product comprising a computer-readable medium carrying computer-readable signals comprising instructions which, when executed by a computer processor, cause the computer processor to execute a method for dispatching a burst of test packets onto a network, the method comprising:
generating a plurality of test packets;
forwarding to an I/O completion port a request that the test packets be dispatched; and,
dispatching the test packets onto the network using the I/O completion port.

24. The program product of claim 18 wherein the instructions comprise a controller section and a test handler section wherein the controller section and test handler section each comprise a separate thread.

25. Apparatus for dispatching bursts of packets onto a computer network, the apparatus comprising:
a computer processor;
a network interface;
a program memory accessible to the processor, the program memory comprising test packet sequencer software comprising a series of instructions executable by the processor under control of an operating system, the instructions, if executed by the processor, causing the processor to:
establish a first I/O completion port;
generate a plurality of test packets;
forward to the first I/O completion port a request that the test packets be dispatched; and,
dispatch the test packets onto the network by way of the network interface under control of the first I/O completion port.

26. The apparatus of claim 25 wherein the test packet sequencer software comprises a test controller layer associated with a second I/O completion port and a command controller layer associated with the first I/O completion port, wherein the test controller layer is configure to pass commands to the command controller layer by way of the first I/O completion port and the command controller layer is configured to pass raw data to the test controller layer by way of the second I/O completion port.
